(19) United States
(12) Patent Application Publication
(10) Pub. No.: US 2021/0017822 A1
(43) Pub. Date: Jan. 21, 2021

(54) DRILLING RIG CARRIAGE MOVABLE ALONG RACKS AND INCLUDING PINIONS DRIVEN BY MOTORS

(71) Applicant: Nabors Drilling Technologies USA, Inc., Houston, TX (US)

(72) Inventors: Derek PATTERSON, Houston, TX (US); Ashish GUPTA, Houston, TX (US)

(21) Appl. No.: 16/932,020

(22) Filed: Jul. 17, 2020

Related U.S. Application Data
(60) Provisional application No. 62/876,420, filed on Jul. 19, 2019.

(51) Int. Cl. E21B 19/06; F16H 19/04

(52) U.S. Cl. CPC E21B 19/06; F16H 19/04

(57) ABSTRACT

A drilling carriage adapted to move along a drilling mast extending in a longitudinal direction includes a body structure having a first side and a second side each parallel to the longitudinal direction and parallel to each other separated in a first direction perpendicular to the longitudinal direction. The drilling carriage includes a first motor having a first output shaft and a second output shaft and a second motor having a third output shaft and a fourth output shaft. The drilling carriage may include a pinion coupled to each of the output shafts. Each pinion may engage a respective rack coupled to the drilling mast.

### CROSS-REFERENCE TO RELATED APPLICATIONS

This application is a nonprovisional application that claims priority from U.S. provisional application No. 62/876,420, filed Jul. 19, 2019, the entirety of which is hereby incorporated by reference in its entirety.

### TECHNICAL FIELD/FIELD OF THE DISCLOSURE

The present disclosure relates in general to drilling rigs, and in particular to a drilling rig employing a carriage movable along racks and including pistons driven by motors.

### BACKGROUND OF THE DISCLOSURE

Drilling rigs typically include one or more hoisting apparatuses. In some drilling rigs, the hoisting apparatus may be a carriage movable along a vertical mast. The carriage may include one or more motors that turn pinions in engagement with racks positioned on the mast to move the carriage vertically.

### SUMMARY

The present disclosure provides for a drilling carriage adapted to move along a drilling mast extending in a longitudinal direction. The drilling carriage may include a body structure having a first side and a second side, the first and second sides parallel to the longitudinal direction and parallel to each other, separated in a first direction perpendicular to the longitudinal direction. The drilling carriage may include a first motor coupled to the body structure, the first motor having a first output shaft and a second output shaft. The drilling carriage may include a first pinion coupled to the first output shaft of the first motor, the first pinion engaged with a first rack coupled to the drilling mast and extending in the longitudinal direction. The drilling carriage may include a second pinion coupled to the second output shaft of the first motor, the second pinion engaged with a second rack coupled to the drilling mast and extending in the longitudinal direction. The drilling carriage may include a second motor coupled to the body structure, the second motor having a third output shaft and a fourth output shaft. The drilling carriage may include a third pinion coupled to the third output shaft of the second motor, the third pinion engaged with a third rack coupled to the drilling mast and extending in the longitudinal direction. The drilling carriage may include a fourth pinion coupled to the fourth output shaft of the second motor, the fourth pinion engaged with a fourth rack coupled to the drilling mast and extending in the longitudinal direction.

The present disclosure also provides for an apparatus. The apparatus may include a drilling mast extending in a longitudinal direction. The drilling mast may include a frame having a first side portion and a second side portion spaced therefrom in a parallel relation and in a first direction that is perpendicular to the longitudinal direction. The drilling mast may include a first rack coupled to the frame at the first side portion thereof. The drilling mast may include a second rack coupled to the frame at the first side portion thereof. The second rack may be spaced from the first rack in a parallel relation and in a second direction that is perpendicular to each of the first direction and the longitudinal extension of the frame. The second rack may face away from the first rack. The drilling mast may include a third rack coupled to the frame at the second side portion thereof and a fourth rack coupled to the frame at the second side portion thereof. The fourth rack may be spaced from the third rack in a parallel relation and in the second direction. The fourth rack may face away from the third rack. The first and second racks may be aligned with the third and fourth racks, respectively, in the second direction. The apparatus may include a drilling carriage adapted to move longitudinally along the drilling mast. The drilling carriage may include a body structure having a first side and a second side, the first and second sides parallel to the longitudinal direction and parallel to each other, separated in a first direction perpendicular to the longitudinal direction. The drilling carriage may include a first motor coupled to the body structure, the first motor having a first output shaft and a second output shaft. The drilling carriage may include a first pinion coupled to the first output shaft of the first motor, the first pinion engaged with the first rack. The drilling carriage may include a second pinion coupled to the second output shaft of the first motor, the second pinion engaged with the third rack. The drilling carriage may include a second motor coupled to the body structure, the second motor having a third output shaft and a fourth output shaft. The drilling carriage may include a third pinion coupled to the third output shaft of the second motor, the third pinion engaged with the second rack. The drilling carriage may include a fourth pinion coupled to the fourth output shaft of the second motor, the fourth pinion engaged with the fourth rack.

The present disclosure also provides for a method. The method may include providing a drilling mast extending in a longitudinal direction. The drilling mast may include a frame having a first side portion and a second side portion spaced therefrom in a parallel relation and in a first direction that is perpendicular to the longitudinal direction. The drilling mast may include a first rack coupled to the frame at the first side portion thereof. The drilling mast may include a second rack coupled to the frame at the first side portion thereof. The second rack may be spaced from the first rack in a parallel relation and in a second direction that is perpendicular to each of the first direction and the longitudinal extension of the frame. The second rack may face away from the first rack. The drilling mast may include a third rack coupled to the frame at the second side portion thereof and a fourth rack coupled to the frame at the second side portion thereof. The fourth rack may be spaced from the third rack in a parallel relation and in the second direction. The fourth rack may face away from the third rack. The first and second racks may be aligned with the third and fourth racks, respectively, in the second direction. The method may also include providing a drilling carriage. The drilling carriage may include a body structure having a first side and a second side, the first and second sides parallel to the longitudinal direction and parallel to each other, separated in a first direction perpendicular to the longitudinal direction. The drilling carriage may include a first motor coupled to the body structure, the first motor having a first output shaft and a second output shaft. The drilling carriage may include a first pinion coupled to the first output shaft of the first motor, the first pinion positioned to engage the first rack. The drilling carriage may include a second pinion coupled to the second output shaft of the first motor, the second pinion positioned to engage the third rack. The drilling carriage may include a second motor coupled to the body structure, the second motor having a third output shaft and a fourth output shaft. The drilling carriage may include a third pinion coupled to the third output shaft of the second motor, the third pinion positioned to engage the second rack. The drilling carriage may include a fourth pinion coupled to the fourth output shaft of the second motor, the fourth pinion positioned to engage the fourth rack. The method may also include coupling the drilling carriage to the drilling mast such that the first, second, third, and fourth pinions mesh with the first, third, second, and fourth racks respectively. The method may also include activating the motors to move the drilling carriage in the longitudinal direction.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a right side elevation view of a portion of a drilling rig consistent with at least one embodiment of the present disclosure.

FIG. 2 is a perspective view of a drilling carriage of the portion of the drilling rig of FIG. 1 consistent with at least one embodiment of the present disclosure.

FIG. 3 is a front elevation view of the drilling carriage of FIG. 2 consistent with at least one embodiment of the present disclosure.

FIG. 4 is a left side elevation and top plan views, respectively, of the drilling carriage of

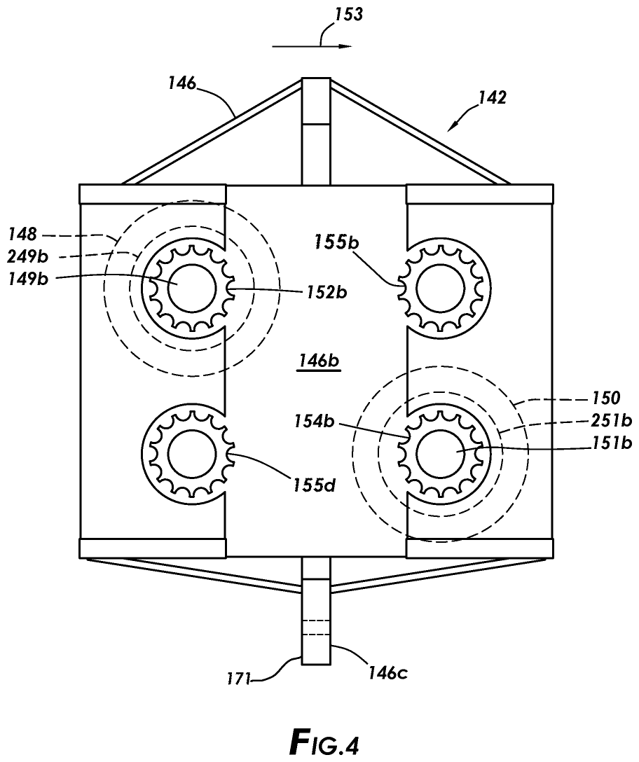

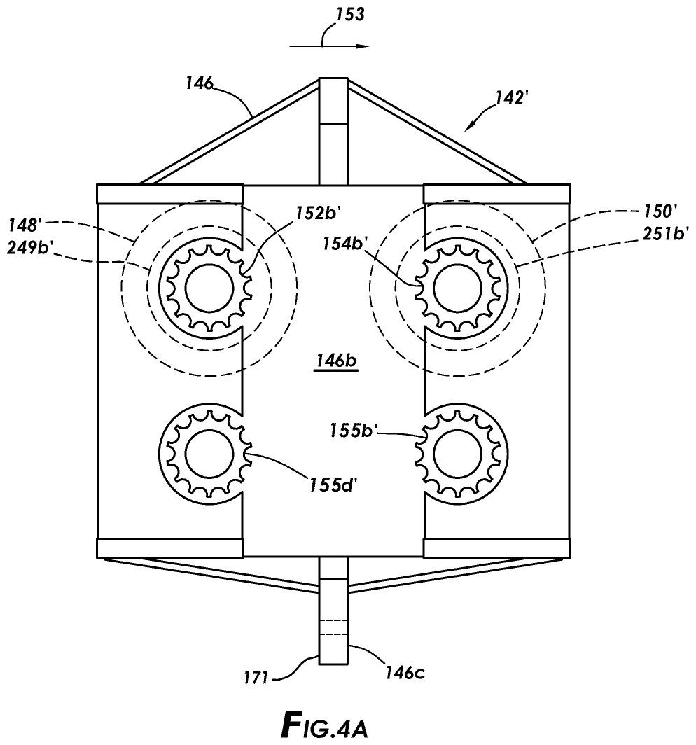

FIG. 2 according to one or more aspects of the present disclosure.

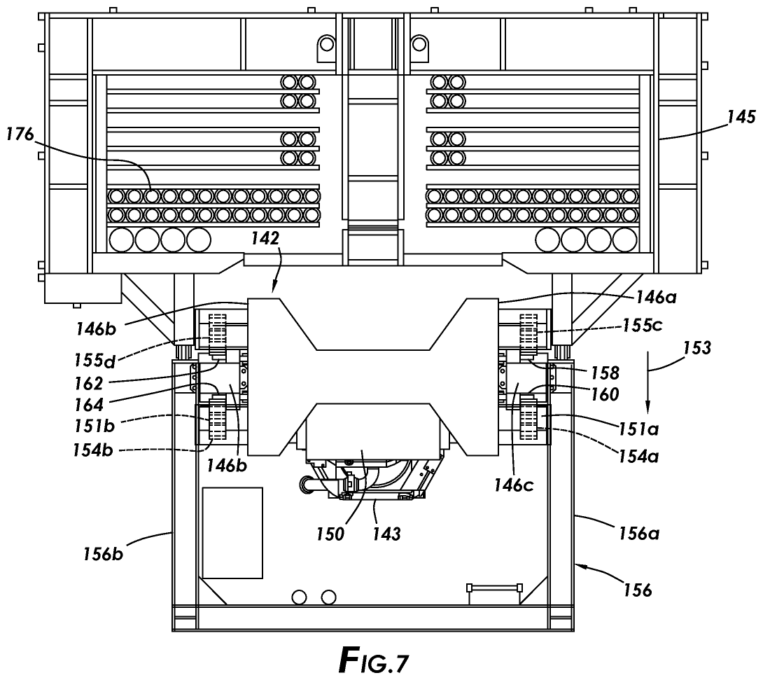

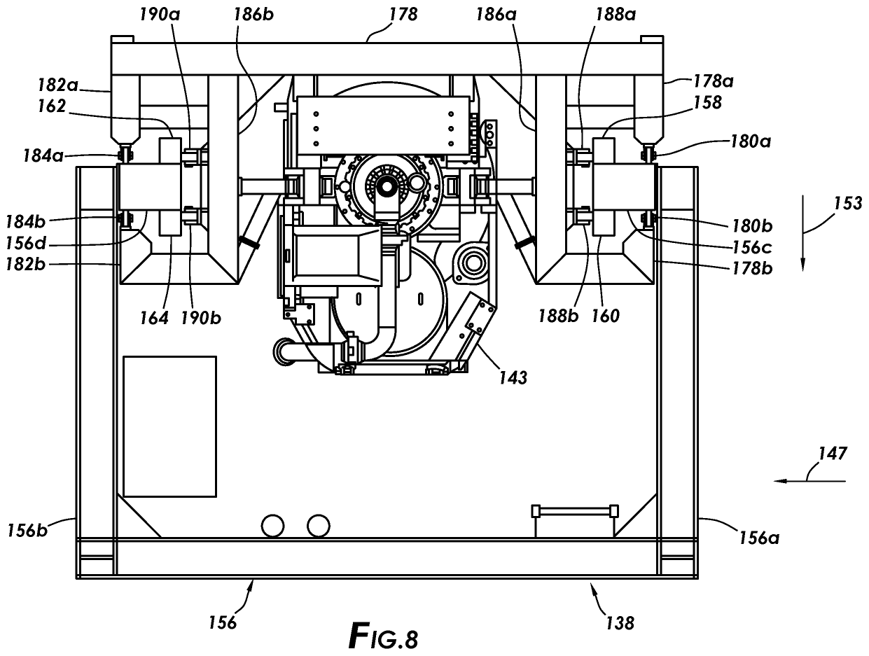

FIG. 4A is a left side elevation view of a drilling carriage consistent with at least one embodiment of the present disclosure.

FIG. 5 is a top plan view of the drilling carriage of FIG. 2 consistent with at least one embodiment of the present disclosure.

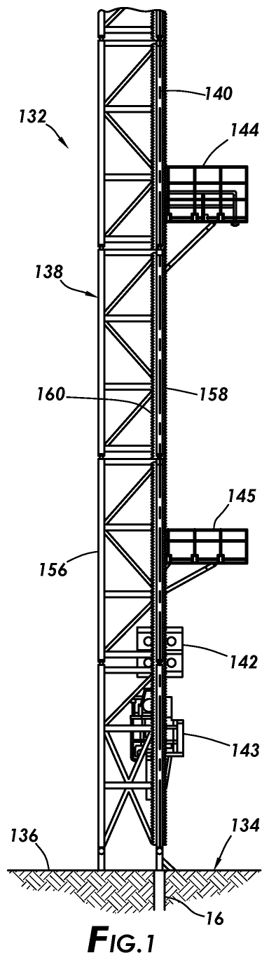

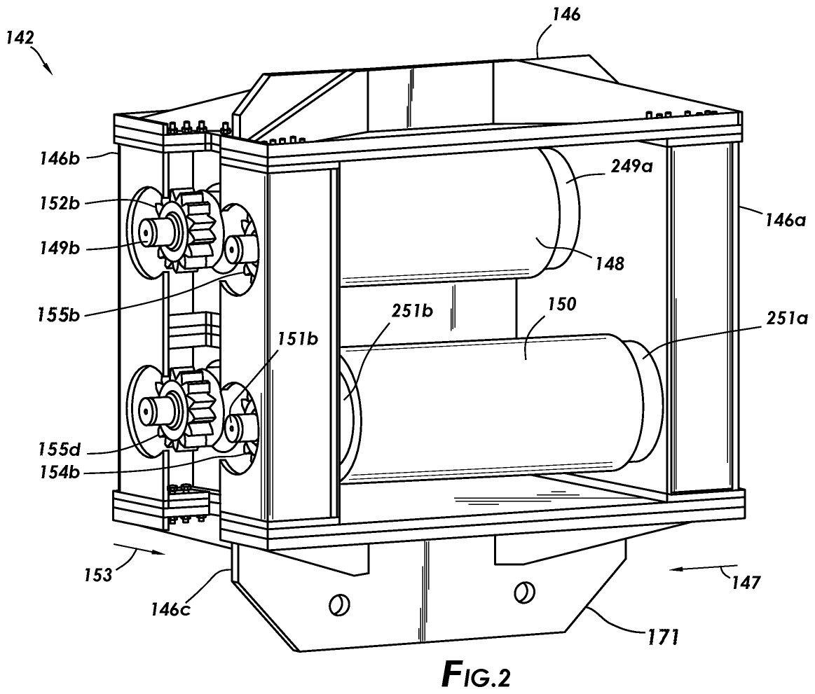

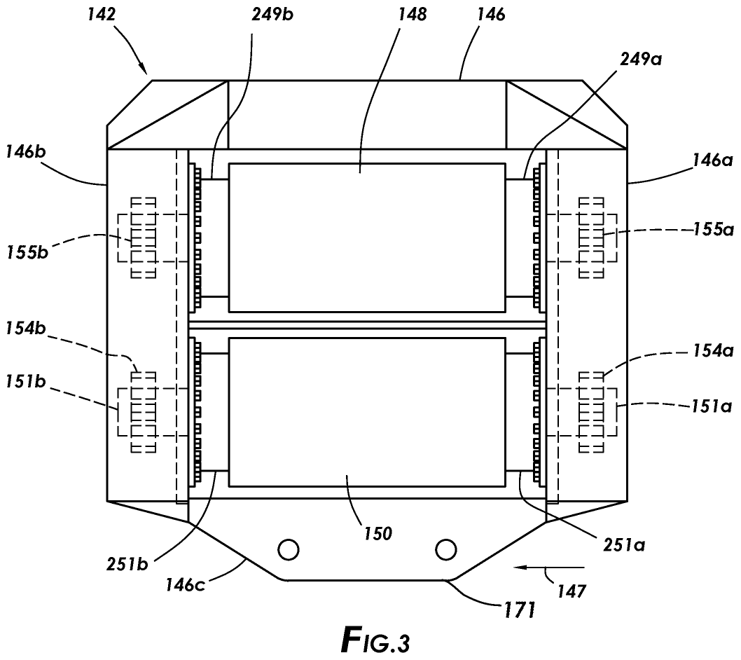

FIG. 6 is a front elevation view of the portion of the drilling rig of FIG. 1 consistent with at least one embodiment of the present disclosure.

FIG. 7 is a sectional view taken along line 7-7 of FIG. 6 consistent with at least one embodiment of the present disclosure.

FIG. 8 is a sectional view taken along line 8-8 of FIG. 6 consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Referring to FIG. 1, illustrated is a right-side elevation view of drilling rig portion 132. Portion of drilling rig 132 may be, include, or be part of, a land-based drilling rig. In several exemplary embodiments, instead of a land-based drilling rig, portion of drilling rig 132 may be, include, or be part of, any type of drilling rig, such as a jack-up rig, a semi-submersible rig, a drill ship, a coil tubing rig, a platform rig, a slant rig, or a casing drilling rig, among others. Portion of drilling rig portion 132 may include a platform 134, which may include rig floor 136 that may be positioned adjacent or above the wellbore 16. In several exemplary embodiments, the platform 134 may be, include, or be a part of, one or more of several types of platforms.

In some embodiments, platform 134 may be part of a land-based drilling rig, where the land-based drilling rig may be adapted to skid or walk through a drilling pad using, for example, skids or walking pods. The land-based drilling rig may skid or walk in two directions, generally known as a two-axis rig. The drill floor of the drilling rig may be oriented so that the V-door may be perpendicular to any substructure boxes, which may allow the rig to skid or walk over existing well heads. Such a drilling rig may include one or all shaker tanks directly pinned to the substructure of the rig to allow continuous connection thereto.

Tower or drilling mast 138 may be coupled to the platform 134 and may extend longitudinally along axis 140. In one embodiment, drilling mast 138 may be releasably coupled to platform 134. In several exemplary embodiments, drilling mast 138 may be characterized as a conventional drilling mast.

Drilling carriage 142 may be movably coupled to drilling mast 138. In some embodiments, a drilling apparatus may be coupled to drilling carriage 142. For example, in some embodiments, top drive 143 may be coupled to drilling carriage 142. Top drive 143 extends longitudinally in a parallel relation to drilling mast 138. As will be described in further detail below, drilling carriage 142 and top drive 143 coupled thereto are movable along axis 140, relative to drilling mast 138. In several exemplary embodiments, portion of drilling rig 132 does not include top drive 143; instead, portion of drilling rig 132 may be, include, or be a part of, another type of drilling rig such as, for example, a rotary-swivel rig or a power-swivel rig. A platform, or racking board 144, may be coupled to drilling mast 138 at a vertical position above rig floor 136. A platform, or belly board 145, may be coupled to drilling mast 138 at a vertical position between rig floor 136 and racking board 144.

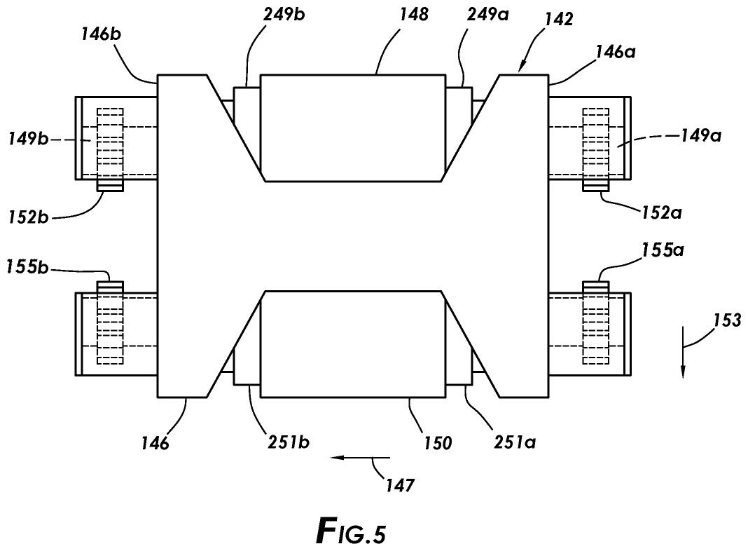

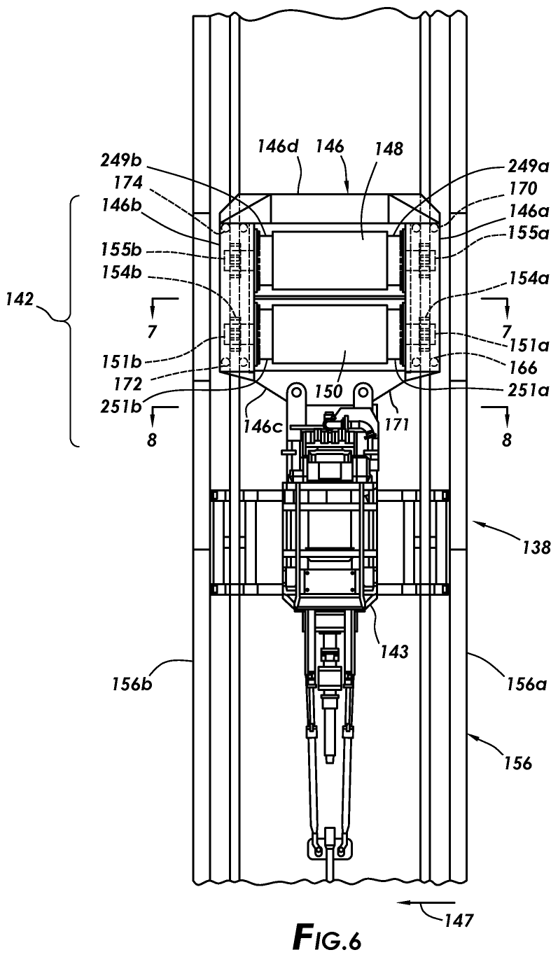

Referring to FIGS. 2-5 illustrated are respective perspective, front elevation, left side elevation, and top plan views of drilling carriage 142. Body structure 146 may include side portions 146a and 146b, which may be spaced in a parallel relation. Side portion 146b may be spaced from side portion 146a in a direction 147 that is perpendicular to the longitudinal extension of drilling mast 138. Lower portion 146c forms attachment point 171 to couple to top drive 143 or other pieces of drilling equipment. In some embodiments, attachment point 171 may include a hook or a hook and swivel.

In some embodiments, drilling carriage 142 may include motors 148 and 150. In some embodiments, motors 148 and 150 may be electric motors or may by hydraulic motors. Motors 148 and 150 may be coupled to side portion 146a and side portion 146b. Motors 148 and 150 may be spaced apart vertically and horizontally as depicted in FIG. 4. In other embodiments, as depicted in FIG. 4A, motors 148′ and 150′ may be spaced apart horizontally. In some embodiments, each of motors 148 and 150 may be a permanent magnet AC electric motor and may be controlled by a single variable-frequency drive (VFD) or multiple VFDs, which may be synchronized and programmed to work simultaneously with each motor to provide uniform motion and torque. In an exemplary embodiment, one or more of motors 148 and 150 may be controlled by a single VFD. In an exemplary embodiment, one or more motors 148 and 150 may be controlled by multiple VFDs. In some embodiments, motors 148 and 150 may be controlled by one or more silicon controlled rectifiers (SCRs). In embodiments in which motors 148 and 150 are hydraulic motors, motors 148 and 150 may be controlled by one or more valves.

In an exemplary embodiment, each of motors 148 and 150 may be a permanent magnet AC motor and may provide primary dynamic braking. In some embodiments, motor 148 may include first and second output shafts 149a, 149b extending from each end of motor 148, and motor 150 may include first and second output shafts 151a, 151b extending from each end of motor 150. In some embodiments, output shafts 149a and 149b may be joined as a single shaft within motor 148 and output shafts 151a and 151b may be joined as a single shaft within motor 150.

In some embodiments, pinions 152a and 152b may be operably coupled to output shafts 149a and 149b of motor 148 and pinions 154a and 154b may be operably coupled to output shafts 151a and 151b of motor 150. Pinions 152a and 154a may be positioned generally at side portion 146a of body structure 146. Pinions 152b and 154b may be positioned generally at side portion 146b of body structure 146. Pinion 152a and pinion 152b may be coupled to outputs from opposite ends of motor 148, and pinions 154a and pinion 154b may be coupled to outputs from opposite ends of motor 150. Pinions 152a and 152b may therefore both be rotated by motor 148 and pinions 154a and 154b may therefore both be rotated by motor 150. In some embodiments, drilling carriage 142 may include one or more idler pinions 155a-d as further discussed below. Each idler pinion 155a-d may be mechanically coupled to a side portion 146a or 146b of body structure 146 such that each idler pinion 155a-d may rotate freely relative to body structure 146.

In some embodiments, each of motors 148, 150 may be coupled to respective pinions 152a, 152b and 154a, 154b through a gearbox. In some embodiments, pinions 152a and 152b may directly couple to output shafts 149a, 149b of motor 148 and pinions 154a and 154b may directly couple to output shafts 151a, 151b of motor 150.

In some embodiments, at least one of output shafts 149a, 149b of motor 148 may pass through brake 249a, 249b. In some embodiments, at least one of output shafts 151a, 15 lb of motor 150 may pass through brake 251a, 251b. Each brake 249a, 249b, 251a, 251b may be, for example and without limitation, a mechanical hydraulic or pneumatic brake located between the respective motor 148, 150 and respective pinions 152a, 152b, 154a, 154b. In some embodiments, brakes 249a, 249b, 251a, 251b may act as a failsafe measure to hold drilling carriage 142 in place. In some embodiments, brakes 249a, 249b, 251a, 251b may have a normally engaged or normally closed design, for example by being spring actuated and opened by a hydraulic system or by air pressure. In such an embodiment, actuation of brakes 249a, 249b, 251a, 251b may disengage or open brakes 249a, 249b, 251a, 251b such that such actuation is needed to allow movement of drilling carriage 142.

In some embodiments in which motors 148 and 150 are electric motors, each of motors 148 and 150 may be used to provide regenerative braking by capturing current induced in the coils of motors 148 and 150 to generate electricity from motion of drilling carriage 142, for example, in response to gravitic forces on a supported drill string. In an exemplary embodiment, each of motors 148 and 150 may include an encoder incorporated on one or more of output shafts 149a, 149b, 151a, 151b to provide more precise VFD control.

Referring to FIGS. 6, 7, and 8, illustrated are a front elevation view, a sectional view taken along line 7-7 of FIG. 6, and a sectional view taken along line 8-8 of FIG. 6, respectively, of portion of drilling rig 132. Drilling mast 138 may include frame 156, which may include side portions 156a and 156b, which may be spaced in a parallel relation. Side portion 156b may be spaced from side portion 156a in the direction 147.

Racks 158 and 160 may be coupled to frame 156 at side portion 156a thereof. In an exemplary embodiment, racks 158 and 160 may be coupled to frame 156 by being integrally formed with frame 156. Rack 160 may be spaced from rack 158 in the direction 153. Rack 160 may face away from rack 158. Similarly, racks 162 and 164 may be coupled to frame 156 at side portion 156b thereof. In an exemplary embodiment, racks 162 and 164 may be coupled to frame 156 by being integrally formed with frame 156. Rack 164 may be spaced from rack 162 in the direction 153. Rack 164 faces away from rack 162. Racks 162 and 164 may be aligned with racks 158 and 160, respectively, in the direction 153.

In some embodiments, pinion 152a may engage rack 158 and pinion 152b may engage rack 162. In some embodiments, pinion 154a may engage rack 160 and pinion 154b may engage rack 164. Pinions 152a and 152b of motor 148 may therefore act on racks 158 and 162 on one side of frame 156, while pinions 154a and 154b of motor 150 act on racks 160 and 164 of the opposite side of frame 156. In some embodiments, idler pinions 155a, 155b may be positioned on racks 160 and 164, respectively, aligned with pinions 152a and 152b. In some embodiments, idler pinions 155c, 155d may be positioned on racks 158 and 162, respectively, aligned with pinions 154a and 154b. Idler pinions 155a-d may thereby oppose any horizontal forces imparted between pinions 152a, 152b, 154a, and 154b and racks 158, 162, 160, and 164, respectively. Idler pinions 155a-d may thereby maintain engagement between pinions 152a, 152b, 154a, and 154b and racks 158, 162, 160, and 164, respectively.

In some embodiments in which motors 148′ and 150′ are aligned horizontally, idler pinions may be omitted. In other such embodiments, idler pinions 155a-d′ may be engaged to racks 158, 160, 162, and 164 at another location along drilling carriage 142′ as shown in FIG. 4A. In such an embodiment, idler pinions 155a-d′ may, for example and without limitation, prevent or reduce rotation of drilling carriage 142′ relative to racks 158, 160, 162, and 164.

In some embodiments, as depicted in FIG. 6, one or more rollers 166 may be coupled to side portion 146a of body structure 146 at a location proximate lower portion 146c. Rollers may engage the respective outer and inner sides of racks 158 and 160, respectively. In some embodiments, rollers 166 may facilitate in guiding drilling carriage 142 as it moves up and down drilling mast 138 and may facilitate in maintaining the respective engagements between pinion 152a and rack 158 and pinion 154a and rack 160.

In some embodiments, one or more rollers 170 may be coupled to side portion 146a at a location proximate top portion 146d of body structure 146. Rollers 172 and 174 may be coupled to side portion 146b at respective locations proximate lower portion 146c and the top portion 146d. Each of rollers 170, 172, and 174 may be substantially identical to the plurality of rollers 166 and may further assist in the engagement between pinion 152a and rack 158 and pinion 154a and rack 160 as well as the engagement between pinion 152b and rack 162 and pinion 154b and rack 164.

As shown in FIG. 7, portion of drilling rig 132 may be capable of racking pipe, and thus supports tubular members (or tubulars) 176, such as drill pipe or casing as part of oil and gas exploration and production operations. In several exemplary embodiments, belly board 145 and/or racking board 144 may be used to support tubular members 176. In several exemplary embodiments, tubular members 176 may be double or triple tubulars. For example and without limitation, in some embodiments, tubular members 176 may be Range II triple tubulars and thus may be about 93 feet long. In several exemplary embodiments, tubular members 176 may be Range III double tubulars and thus may be about 92 feet long. In several exemplary embodiments, tubular members 176 may be Range II tubulars and thus may be about 31 feet long. In several exemplary embodiments, tubular members 176 may be Range III tubulars and thus may be about 46 feet long.

As shown in FIG. 8, top drive 143 may be coupled to body structure 178, which may be movable with top drive 143 and drilling carriage 142. Body structure 178 may include arms 178a and 178b, to which rollers 180a and 180b may be coupled, respectively. Rollers 180a and 180b respectively engage opposing sides of a vertically-extending member 156c of frame 156 of drilling mast 138. Body structure 178 further may include arms 182a and 182b, to which rollers 184a and 184b may be coupled, respectively. Rollers 184a and 184b respectively engage opposing sides of a vertically-extending member 156d of frame 156 of drilling mast 138. Arm 186a may be coupled between top drive 143 and arms 178a and 178b, and arm 186b may be coupled between top drive 143 and arms 182a and 182b. Rollers 188a and 188b may be coupled to arm 186a and may engage the respective inner sides of racks 158 and 160. Rollers 190a and 190b may be coupled to arm 186b and may engage the respective inner sides of racks 162 and 164. Rollers 180a, 180b, 184a, 184b, 188a, 188b, 190a and 190b may, for example and without limitation, facilitate in guiding top drive 143 as it moves up and down drilling mast 138, and facilitate in maintaining the respective engagements between pinion 152a and rack 158, pinion 154a and rack 160, pinion 152b and rack 162, and pinion 154b and rack 164.

In operation, in an exemplary embodiment with continuing reference to FIGS. 1-8, portion of drilling rig 132 may be employed to assemble or disassemble a string of tubular members 176 such as during a drilling operation or tripping operation. More particularly, at least one of tubular members 176 may be coupled to top drive 143, which may operate to couple (or separate) that tubular member 176 to (or from) another of tubular members 176 which already extends within the wellbore 16 or may be vertically positioned between the wellbore 16 and the tubular member 176 coupled to top drive 143. For all embodiments described herein, the operations disclosed herein may be conducted in reverse to trip pipe or casing out of a wellbore and disassemble tubular members or pairs of tubular members from the string of tubular members. As noted above, in several exemplary embodiments, tubular members 176 may be Range II tubulars, and/or tubular members 176 may be Range III tubulars.

Actuation of motor 148 may cause pinions 152a, 152b to rotate and engage teeth of racks 158, 162. Actuation of motor 150 may cause pinions 154a, 154b to rotate and engage teeth of racks 160, 164. As a result, drilling carriage 142 and thus top drive 143 may move upward or downward depending on the direction of rotation of motors 148, 150, along axis 140 and relative to drilling mast 138 as necessary, so that top drive 143 may be at a position along axis 140 at which one of tubular members 176 can be coupled to top drive 143.

Motors 148, 150 may move top drive 143 downward along axis 140 and relative to drilling mast 138, lowering the tubular member 176 coupled to top drive 143. Before, during or after this lowering, top drive 143 may operate to couple the tubular member 176 coupled to top drive 143 to another of tubular members 176 either extending in the wellbore 16 or being vertically positioned between the wellbore 16 and the tubular member 176 coupled to top drive 143; this other tubular member 176 may be part of a string of drill pipe or casing.

In several exemplary embodiments, during the upward and/or downward movement of top drive 143, rollers 166, 170, 172, 174 may facilitate in guiding drilling carriage 142 as it moves up and down drilling mast 138 and may facilitate in maintaining the respective engagements between pinions 152a, 152b, 154a, 154c and racks 158, 162, 160, and 164, respectively. Similarly, in several exemplary embodiments, rollers 180a, 180b, 184a, 184b, 188a, 188b, 190a and 190b may facilitate in guiding top drive 143 as it moves up and down drilling mast 138 and may facilitate in maintaining the respective engagements between pinions 152a, 152b, 154a, 154c and racks 158, 162, 160, and 164, respectively.

In several exemplary embodiments, the arrangement of rack 158 and rack 160 facing away from rack 158 at side portion 156a of frame 156 may reduce the degree to which racks 158 and 160 undergo bending and/or torsional loading, thereby reducing the risk of unacceptable stress and strain levels in frame 156 and racks 158 and 160. Likewise, in several exemplary embodiments, the arrangement of rack 162 and rack 164 facing away from rack 162 at side portion 156b of frame 156 may reduce the degree to which racks 162 and 164 undergo bending and/or torsional loading, thereby reducing the risk of unacceptable stress and strain levels in frame 156 and racks 162 and 164.

In some embodiments, portion of drilling rig 132 may be used with any drilling rig configured to operate at any height or with any length of tubulars. For example, in some embodiments, portion of drilling rig 132 may be used with a singles rig. In some embodiments, portion of drilling rig 132 can be used with a conventional style drilling mast capable of handling tubular Range II triples, tubular Range II Quads, or tubular Range III doubles and capable of racking pipe. In several exemplary embodiments, portion of drilling rig 132 may be capable of racking pipe in drilling mast 138, increasing drilling speed, and providing off-line stand building, among other capabilities.

In several exemplary embodiments, portion of drilling rig 132 or components thereof may be used in a wide variety of drilling applications including, but not limited to, horizontal drilling applications, thermal drilling applications, etc.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A drilling carriage, the drilling carriage comprising:
a body structure having a first side and a second side, the first and second sides parallel to the longitudinal direction and parallel to each other, separated in a first direction perpendicular to the longitudinal direction;
a first motor coupled to the body structure, the first motor having a first output shaft and a second output shaft;
a first pinion coupled to the first output shaft of the first motor, the first pinion engaged with a first rack coupled to a drilling mast and extending in the longitudinal direction;
a second pinion coupled to the second output shaft of the first motor, the second pinion engaged with a second rack coupled to the drilling mast and extending in the longitudinal direction;
a second motor coupled to the body structure, the second motor having a third output shaft and a fourth output shaft;
a third pinion coupled to the third output shaft of the second motor, the third pinion engaged with a third rack coupled to the drilling mast and extending in the longitudinal direction; and
a fourth pinion coupled to the fourth output shaft of the second motor, the fourth pinion engaged with a fourth rack coupled to the drilling mast and extending in the longitudinal direction.

2. The drilling carriage of claim 1, wherein the first motor is offset horizontally from the second motor.

3. The drilling carriage of claim 2, wherein the first motor is offset horizontally and vertically from the second motor.

4. The drilling carriage of claim 1, wherein the body structure further comprises an attachment point.

5. The drilling carriage of claim 1, further comprising:
a plurality of rollers coupled to the body structure positioned to rollingly contact the drilling mast to maintain the pinions in continuous contact with each pinion's respective rack.

6. The drilling carriage of claim 1, wherein the motors are hydraulic motors.

7. The drilling carriage of claim 1, wherein the motors are electric motors.

8. The drilling carriage of claim 7, wherein each electric motor is driven by a variable frequency drive or a silicon controlled rectifier.

9. The drilling carriage of claim 7, wherein the electric motors are configured to provide regenerative braking.

10. The drilling carriage of claim 1, wherein one or more of the first, second, third, or fourth output shafts includes a brake.

11. The drilling carriage of claim 10, wherein the brake is pneumatically actuated.

12. The drilling carriage of claim 10, wherein the brake is hydraulically actuated.

13. The drilling carriage of claim 10, wherein the brake is normally closed, and actuates to release the motion of the drilling carriage.

14. The drilling carriage of claim 1, further comprising an idler pinion coupled to the body structure, the idler pinion engaged with the third rack and aligned vertically with the first pinion.

15. The drilling carriage of claim 1, wherein the first and second output shafts are joined as a single shaft within the first motor or the third and fourth output shafts are joined as a single shaft within the second motor.

16. An apparatus comprising:
a drilling mast extending in a longitudinal direction having:
a frame having a first side portion and a second side portion spaced therefrom in a parallel relation and in a first direction that is perpendicular to the longitudinal direction;
a first rack coupled to the frame at the first side portion thereof;
a second rack coupled to the frame at the first side portion thereof, the second rack spaced from the first rack in a parallel relation and in a second direction that is perpendicular to each of the first direction and the longitudinal extension of the frame, the second rack facing away from the first rack; and
a third rack coupled to the frame at the second side portion thereof; and a fourth rack coupled to the frame at the second side portion thereof, the fourth rack spaced from the third rack in a parallel relation and in the second direction; and the fourth rack facing away from the third rack, the first and second racks aligned with the third and fourth racks, respectively, in the second direction; and
a drilling carriage adapted to move longitudinally along the drilling mast, the drilling carriage including:
a body structure having a first side and a second side, the first and second sides parallel to the longitudinal direction and parallel to each other, separated in a first direction perpendicular to the longitudinal direction;
a first motor coupled to the body structure, the first motor having a first output shaft and a second output shaft;
a first pinion coupled to the first output shaft of the first motor, the first pinion engaged with the first rack;
a second pinion coupled to the second output shaft of the first motor, the second pinion engaged with the third rack;
a second motor coupled to the body structure, the second motor having a third output shaft and a fourth output shaft;
a third pinion coupled to the third output shaft of the second motor, the third pinion engaged with the second rack; and
a fourth pinion coupled to the fourth output shaft of the second motor, the fourth pinion engaged with the fourth rack.

17. The apparatus of claim 16, further comprising a top-drive coupled to a lower end of the body structure of the drilling carriage positioned to assemble or disassemble a string of tubular members and movable in the longitudinal direction by a longitudinal movement of the drilling carriage.

18. The apparatus of claim 16, wherein the drilling mast is separable into two or more longitudinal pieces.

19. The apparatus of claim 16, wherein the motors are hydraulic motors.

20. The apparatus of claim 16, wherein the motors are electric motors.

21. The apparatus of claim 20, wherein the electric motors are configured to provide regenerative braking in response to an upward or downward movement of the drilling carriage.

22. The apparatus of claim 16, wherein the drilling mast further comprises at least one platform extending in a second direction, perpendicular to the longitudinal and first directions positioned to support tubular members in a vertical position.

23. The apparatus of claim 16, further comprising a base to which the drilling mast is pivotally coupled to allow the drilling mast to pivot between a first and second pivot position.

24. The apparatus of claim 16, further comprising an idler pinion coupled to the body structure, the idler pinion engaged with the second rack and aligned vertically with the first pinion.

25. The apparatus of claim 16, wherein the first and second output shafts are joined as a single shaft within the first motor or the third and fourth output shafts are joined as a single shaft within the second motor.
